(19) United States
(12) Patent Application Publication
(10) Pub. No.: US 2024/0251249 A1
(43) Pub. Date: Jul. 25, 2024

(54) CENTRALIZED AFC SYSTEM INFORMATION FUNCTION AND PROCEDURES IN 6 GHz AFC CONTROLLED NETWORKS

(71) Applicant: Telefonaktiebolaget LM Ericsson (publ), Stockholm (SE)

(72) Inventor: Christopher Richards, Ottawa (CA)

(21) Appl. No.: 18/561,369

(22) PCT Filed: May 27, 2022
(86) PCT No.: PCT/IB2022/055028

§ 371 Date: Nov. 16, 2023

Related U.S. Application Data
(60) Provisional application No. 63/193,797, filed on May 27, 2021.

(51) Int. Cl. H04W 16/14

(52) U.S. Cl. CPC H04W 16/14

(57) ABSTRACT

Embodiments of a method performed by an Automatic Frequency Coordination (AFC) service provider database is disclosed, where the AFC service provider database maintains records of AFC service providers and/or AFC systems. In some embodiments, the method can include receiving, from a network node associated with an AFC service provider or AFC operator, a request to add, modify, delete, or view information about the AFC service provider and/or an AFC system of the AFC service provider. In some embodiments, the method can also include performing one or more actions responsive to the request.

### RELATED APPLICATIONS

This application claims the benefit of provisional patent application Ser. No. 63/193,797, filed May 27, 2021, the disclosure of which is hereby incorporated herein by reference in its entirety.

### TECHNICAL FIELD

The present disclosure relates to a wireless communication system, and more specifically to Automatic Frequency Coordination (AFC) in a wireless communication system.

### BACKGROUND

In the United States of America (USA) (and other regulatory jurisdictions such as Canada), the 6 Gigahertz (GHz) frequency range is being opened up for unlicensed use. There are existing “incumbent” operations in this frequency band, which are typically fixed microwave links, and draft regulations require that these operations are protected from harmful interference caused by unlicensed operations.

The Federal Communications Commission (FCC) in the USA and the Innovation, Science and Economic Development (ISED) in Canada are requiring that spectrum assignments for full power (“standard power”) unlicensed operations are controlled by an Automatic Frequency Coordination (AFC) system. The unlicensed base stations, e.g., Institute of Electrical and Electronics Engineers (IEEE) 802.11 access points or Third Generation Partnership Project (3GPP) New Radio (NR) base stations (gNBs), must provide location and other transmitter information to the AFC system in order for the AFC system to determine what frequency ranges can be used by the base station at that location and at what transmitter power levels so that incumbent services are not impacted. The base station must then operate within the permitted frequencies and limits provided by the AFC system.

Signaling procedures between the base station and the AFC system are being defined by industry forums such as the Wi-Fi Alliance (WFA) and WinnForum. The FCC 6 GHz Report & Order only defines the high level requirements and not the specific signaling protocol(s) and procedures. The details are left to industry and industry forums.

Paragraph 83 of the FCC 6 GHz Report & Order includes descriptions of a number of End-to-End procedures that should be defined. Paragraph 83 reads as follows:
83. To register, a standard-power access point will be required to provide the AFC system—in addition to the technical information described above with the device's FCC identifier (FCC ID), and its serial number. Although the FCC ID or the access point's serial number are not required to calculate frequency availability, the AFC will use the information for two purposes. First, the information will be used to authenticate the device, to ensure that no rogue devices are operating in the band. The AFC will verify the device's FCC ID by accessing the Commission's Equipment Authorization System. Second, the information will be used for interference mitigation and enforcement purposes to identify the source if harmful interference were to occur. In addition, as APCO and UTC request and as we have done in the context of the white space devices, we will require that AFC systems have the capacity to deny spectrum access to a particular registered standard-power access point upon request by the Commission, in the event of harmful interference caused by a particular device or type of device. We will also require that AFC operators implement procedures to respond to requests from Commission personnel for information stored or maintained by the AFC, and that they establish and follow protocols to comply with enforcement instructions from the Commission, including discontinuance of access point operations in designated geographic areas. These requirements will ensure that the Commission is able to ascertain the accuracy of information stored in the AFC, obtain information necessary to enforce the Commission's rules, and ensure that access points that do not comply with the rules are shut down in a timely manner.

### SUMMARY

Methods and apparatuses are disclosed herein for an Automatic Frequency Coordination (AFC) service provider database that maintains records of AFC service providers and/or AFC systems. In some embodiments, a method performed by an AFC service provider database that maintains records of AFC service providers and/or AFC systems comprises receiving, from a network node associated with at least one of an AFC service provider or an AFC operator, a request to add, modify, delete, or view information about the AFC service provider and/or an AFC system of the AFC service provider. The method can also comprise performing an action responsive to the request. Thus, embodiments of the present disclosure can ensure that the Federal Communications Commission is able to ascertain the accuracy of information stored in the AFC, obtain information necessary to enforce the Commission's rules, and ensure that access points that do not comply with the rules are shut down in a timely manner.

In an embodiment, the method can further comprise receiving, from an authorized entity, a query for AFC service providers. The method can also include responsive to receiving the query, sending, to the authorized entity, a query response that comprises a list of AFC service providers that satisfy the query.

In an embodiment, the query comprises criteria, and the list of AFC service providers comprises one or more AFC service providers that satisfy the criteria comprised in the query.

In an embodiment, the criteria comprised in the query comprises at least one of a geographic location, a geographic region, a time range, a frequency, a frequency range, and/or a Federal Communication Commission Identifier (FCC-ID).

In an embodiment, the method further comprises communicating with an incumbent operator to update an authorized user access list for the AFC service provider database.

In an embodiment, the method further comprises receiving, from an incumbent operator, a query for the AFC service providers and responsive to receiving the query, sending, to the incumbent operator, a query response that comprises a list of AFC service providers that satisfy the query.

In an embodiment, the query comprises criteria, and the list of AFC service providers comprises one or more AFC service providers that satisfy the criteria comprised in the query.

In an embodiment, the criteria comprised in the query comprises at least one of a geographic location, a geographic region, a time range, a frequency, a frequency range, and/or a FCC-ID.

In an embodiment, the method further comprises receiving, from an AFC system, a query for an authorized user access list and sending the authorized user access list to the AFC system responsive to receiving the query for the authorized user access list.

In an embodiment, a method performed by an AFC service provider database that maintains records of AFC service providers and/or AFC systems comprises receiving, from another entity, a query for AFC service providers and responsive to receiving the query, sending, to the other entity, a query response that comprises a list of AFC service providers that satisfy the query.

In an embodiment, the query comprises criteria, and the list of AFC service providers comprises one or more AFC service providers that satisfy the criteria comprised in the query.

In an embodiment, the criteria comprised in the query comprises at least one of a geographic location, a geographic region, a time range, a frequency, a frequency range, and/or a FCC-ID.

In an embodiment, the other entity is at least one of an authorized entity or an incumbent system operated by an incumbent operator.

In an embodiment, a network node comprises processing circuitry configured to cause the network node to receive, from another network node associated with at least one of an AFC service provider or an AFC operator, a request to add, modify, delete, or view information about the AFC service provider and/or an AFC system of the AFC service provider. The processing circuitry also causes the network node to perform an action responsive to the request.

In an embodiment, the processing circuitry also causes the network node to receive, from an authorized entity, a query for AFC service providers and responsive to receiving the query, send, to the authorized entity, a query response that comprises a list of AFC service providers that satisfy the query.

In an embodiment, the query comprises criteria, and the list of AFC service providers comprises one or more AFC service providers that satisfy the criteria comprised in the query.

In an embodiment, the criteria comprised in the query comprises at least one of a geographic location, a geographic region, a time range, a frequency, a frequency range, and/or a FCC-ID.

In an embodiment, the processing circuitry also causes the network node to communicate with an incumbent operator to update an authorized user access list for the AFC service provider database.

In an embodiment, the processing circuitry also causes the network node to receive, from an incumbent operator, a query for the AFC service providers and responsive to receiving the query, sending, to the incumbent operator, a query response that comprises a list of AFC service providers that satisfy the query.

In an embodiment, the query comprises criteria, and the list of AFC service providers comprises one or more AFC service providers that satisfy the criteria comprised in the query.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a wireless communications system in which embodiments of the present disclosure may be implemented;

FIG. 2 illustrates one example of a message sequence chart of a wireless communication system implementing Automatic Frequency Coordination (AFC) according to one or more embodiments of the present disclosure;

FIG. 3 illustrates another example of a message sequence chart of a wireless communication system implementing AFC according to one or more embodiments of the present disclosure;

FIG. 4 illustrates another example of a message sequence chart of a wireless communication system implementing AFC according to one or more embodiments of the present disclosure;

FIG. 5 illustrates a schematic block diagram of a network node according to one or more embodiments of the present disclosure; and

FIG. 6 illustrates another schematic block diagram of the network node according to one or more embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Automatic Frequency Coordination (AFC) System: As used herein, an “AFC System” is a system that automatically determines and provides information about which frequency, frequencies, or frequency ranges is/are available for use by a base station (e.g., a Third Generation Partnership Project (3GPP) base station such as, e.g., a New Radio (NR) base station (gNB) or an Institute of Electrical and Electronics Engineers (IEEE) 802.11 Access Point (AP)). In one embodiment, an AFC system is a system that automatically determines and provides information about (e.g., lists) of frequencies are available for use by standard power access points operating in the 5.925-6.425 Gigahertz (GHz) and 6.525-6.875 GHz bands. In one embodiment, the determined/provides information may be related to a particular geographic location or particular geographic area such that the information is about which frequency, frequencies, or frequency ranges is/are available for use by a base station at a particular geographic location or within a particular geographic region, e.g., so as to not impact incumbent (e.g., existing) services. The AFC System may be a centralized system or a de-centralized system. The AFC System accesses a database (for example, the Universal Licensing System Database, Ref paragraph 30 in Federal Communications Commission (FCC) R&O) that, e.g., is queried based on the geographic location of the base station to obtain information about any incumbent services operating in the applicable unlicensed frequency spectrum at or near that geographic location and/or information about frequency range(s) and/or transmitter power level(s) that a base station is permitted to use at that particular geographic location (e.g., an within the applicable unlicensed frequency spectrum). An AFC system may be queried or otherwise communicated with obtain information about a frequency range(s) and transmitter power level(s) that a base station is permitted to use at a particular geographic location, e.g., via an appropriate interface.

AFC Service Provider: As used herein, an “AFC Service Provider” is an entity (e.g., a person, business, organization, or other legal entity) that operates and controls an AFC system.

There currently exist certain challenge(s). The specifications being developed in the WinnForum 6 Gigahertz (GHz) working groups do not address any End-to-End (E2E) procedures that are described (and required) in Paragraph 83 of the FCC 6 GHz Report & Order.

Section 15.407 of Title 47 of the Code of Federal Regulations (CFR) describes a number of general technical requirements. In relevant part, Section 15.407 states:
15.407 General technical requirements
. . .
15(vi) Establish and follow protocols to comply with enforcement instructions from the Commission, including discontinuance of standard power access point operations in designated geographic areas.

There are only a few practical mechanisms that can satisfy those E2E procedures.

Certain aspects of the present disclosure and their embodiments may provide solutions to the aforementioned or other challenges. Systems and methods disclosed herein relate to a new network database (DB) function that stores AFC provider and system records.

Embodiments of present disclosure provide new signaling (e.g., new messages) that is sent and received by the new DB function, and define the context of these messages.

Embodiments of the present disclosure provide new signaling (e.g., new messages) that are sent to and from an AFC system, and define content of these messages.

The new DB function and messages enable the implementation and development of products that can perform the procedures outlined in the FCC 6 GHz Report & Order (para 83).

Similar procedures will be included by other national spectrum regulators that open the 6 GHz band for unlicensed use, e.g. Canada, UK.

Embodiments of the present disclosure have the potential to be incorporated into procedures defined in standards such as, e.g., the WinnForum 6 GHz standards.

Certain embodiments may provide one or more of the following technical advantage(s). Embodiments of the aspects of the present disclosure may provide end to end mechanisms and procedures for querying and controlling 6 GHz unlicensed devices as required by the FCC Report & Order. The users of these procedures and messages include any one or more of the following entities:
1) Spectrum regulators (e.g., The Commission): compliance, spectrum policy
2) Incumbent service providers, e.g. AT&T,
3) Incumbent infrastructure vendor suppliers, e.g. Ericsson, Nokia
4) Unlicensed base station service providers or vendors, e.g. Cisco, HPE,
5) AFC service providers, e.g. CommScope, Federated Wireless.

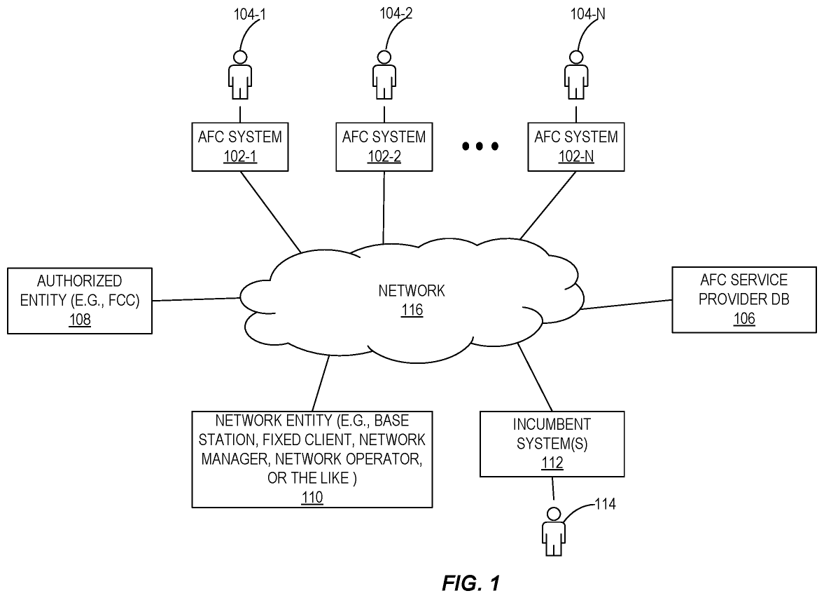

FIG. 1 illustrates a system 100 in accordance with one example embodiment of the present disclosure. As illustrated, the system 100 includes a number of AFC systems 102-1 through 102-N, which are generally referred to herein collectively as AFC systems 102 and individually as AFC system 102. The AFC systems 102-1 through 102-N are associated to respective AFC service providers 104-1 through 104-N, which are generally referred to herein collectively as AFC service providers 104 and individually as AFC service provider 104. Each AFC system 102 is a centralized or de-centralized computer-implemented system that includes one or more network nodes (e.g., one or more server computers). The system 100 also includes an AFC service provider database 106, which is described below in detail. Importantly, the AFC service provider database 106 stores information about the AFC systems 102 of the AFC service providers 104 and can be queried to, e.g., obtain information about AFC systems 102 that satisfy one or more criteria (e.g., one or more geographic location based criteria, one or more time based criteria, or the like).

The system 100 may also include an authorized entity 108 (e.g., FCC in the USA) that is able to communicate with the AFC systems 102 (e.g., via a web-browser, software application, or the like), a network entity 110 (e.g., a base station, fixed client, network manager, network operator, or the like) corresponding to or associated with a base station desiring to operate in an unlicensed spectrum, an incumbent system(s) 112 having associated incumbent operator(s) 114. The network entity 106 may be a network node (e.g., a network node that is or is part of the base station, a network node that implements a management function associated with the base station, a person such as an employee of a network operator associated to the base station, or the like).

Regarding the AFC service provider database 106, the purpose of the AFC service provider database 106 is to provide specific AFC system access details (URLs, etc.) of AFC systems 102 of interest for further queries or actions. Users of the AFC service provider database 106 include, e.g., the authorized entity 108, the AFC service providers 104, and the incumbent operator(s) 114. In one embodiment, the AFC service provider database 106 is a passive database and does not initiate any procedures or actions. The AFC service provider database 106 maintains a list of all AFC service providers 104 along with contact details and M2M access/interface (URL(s)). The AFC service provider database 106 is preferably not a public accessible DB. In one embodiment, the AFC service provider database 106 uses authorized, authenticated, secure network interfaces to access data. In one embodiment, the AFC service provider database 106 has a Machine to Machine (M2M) API interface (e.g., TLS/HTTPS/JSON) that enables at least some of the following actions:
add, modify, delete, and/or view database entries of the AFC systems 102/AFC service providers 104, which may be restricted based on user access,
Inquiry Request/Inquiry Response—serves contact data for AFC Log Management Function(s) (e.g., part of the AFC systems 102) that serve network devices in the geography and/or time range of interest,
serve authorized user access list updates periodically (e.g., same as ULS update pull) to AFC (Log Mgmt function).

In one embodiment, the various nodes in the system 100 are communicatively connected via a network(s) 116, which may be a public network (e.g., the Internet) or a private network, or any combination thereof.

In one embodiment, the AFC service provider database 106 is a logical function (e.g., implemented on or by one or more network nodes (e.g., one or more server computers) in a centralized or de-centralized manner). The AFC service provider database 106 stores a list of active (and authorized) AFC service providers 104 along with the details, e.g., access URLs, etc., of the associated AFC systems 102.

Users of the AFC service provider database 106 may include, e.g.:
the authorized entity 108, which may be, for example, a National Spectrum Regulator, e.g., the FCC in the USA,
the incumbent operator(s) 114, e.g., licensed incumbent 6 GHz operators, and/or
the AFC service providers 104.

The AFC system 102 includes, in one embodiment, an AFC log management function or similar function that manages logging of externally accessible log data and provide (e.g., secure) M2M access to authorized and authenticated devices to query specific logs and perform specific actions. Users include the authorized entity 108 and the incumbent operator(s) 114. The following functions are provided (e.g., via M2M API interfaces (e.g., TLS/HTTPS/JSON):
Inquiry Request/Inquiry Response API: serves AP network log info (e.g., contact information) to authorized clients/users.
Get/Receive authorized user access list updates periodically (e.g., same as ULS update pull) from AFC service provider database 106.
Deny Request/Deny Response API: Used by the authorized entity 108 to control spectrum access to a device or group of devices, potentially filtered by FCC-ID, geography, time, etc.

In one embodiment, the AFC service provider database 106 is a passive database. More specifically, the AFC service provider database 106 receives information records and serves information records.

Without the AFC service provider database 106, the authorized entity 108 and the incumber operator(s) 114 will have no way of knowing what AFC service providers 104 and AFC systems 102 exist. In other words, the authorized entity 108 and the incumber operator(s) 114 will have no way of knowing what AFC service providers 104 and AFC systems 102 to query in order to perform the procedures required by, e.g., FCC 6 GHz Report & Order (para 83).

The AFC service provider database 106 maintains a list of all AFC service providers 104 and/or all AFC systems 102, along with contact details and M2M access/interface (URL(s)).

The AFC service provider database 106 is not publicly accessible. In one embodiment, the AFC service provider database 106 uses authorized, authenticated, secure network interfaces to access data stored by the AFC service provider database 106.

The AFC service provider database 106 implements a signaling message interface (e.g., TLS/HTTPS/JSON) to:
perform add, modify, delete, and/or view operations to add/modify/delete/view DB entries related to the AFC systems 102 and/or the AFC service providers 104 (e.g., restricted based on user access),
perform Inquiry Request/Inquiry Response operations by which it serves contact data for AFC systems (e.g., AFC Log Management Function(s) of AFC systems) that serve network devices in the geography/time range of interest, and/or
serve authorized user access list updates periodically (e.g., same as Universal Licensing System (ULS) update pull) to AFC system 102 (e.g., AFC Log Management function). Note that the ULS is an existing FCC database.

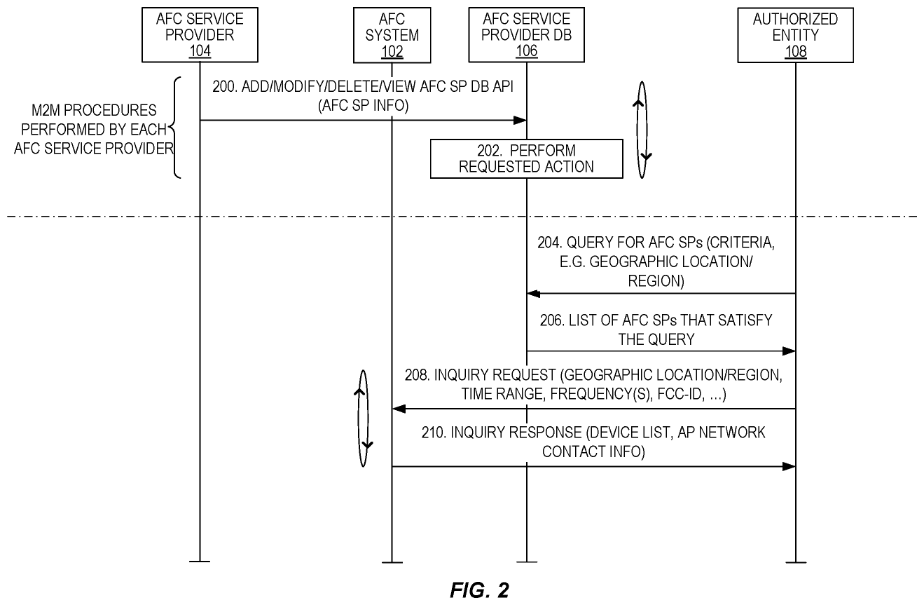

Embodiments are described herein that define and use signaling interface messages to add, modify, delete, and/or view DB entries stored by the AFC service provider database 106. For example, an AFC service provider 104 may add, modify, delete, or view data stored in the AFC service provider database 106 for the associated AFC system 102 using message exchange of steps 200-202 of FIG. 2, which is described below in detail.

Embodiments are disclosed herein for defining signaling interface messages to request the list of active AFC systems 102 (see, e.g., FIG. 2, steps 206-208).

A user may query the AFC service provider database 106 for a list of active AFC systems 102 and their associated data. The query may include filters such as, e.g., geographic area, time range, AFC Operator name (e.g., AFC service provider name).

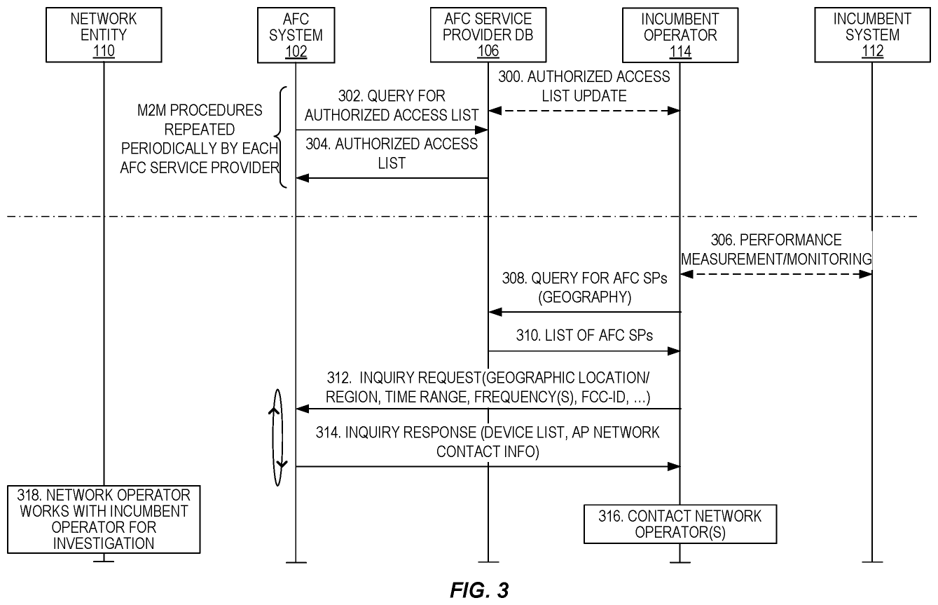

Embodiments are also disclosed herein for defining signaling interface messages to request the authorized user list (see, e.g., steps 302-304 of FIG. 3).

The messages may include a time range used to filter the request.

The messages may use FCC-Id or manufacturer or device product name or device serial number.

The messages may include a geographical area within which the request applies to a device of set of devices.

Embodiments are disclosed herein for defining signaling interface messages between an AFC system 102 and an authorized user system to obtain the records of a device or list of devices (see, e.g., steps 312-314 of FIG. 3).

Embodiments are disclosed herein for defining signaling interface messages between an AFC system 102 and an authorized user system to control the spectrum allocation of the AFC system 102 to a device or group of devices (see, e.g., steps 410-412).

For example, the message may instruct the AFC system 102 to deny or limit any spectrum allocation to a device or set of devices currently or in the future under the control of that AFC system 102.

The message may further remove a “deny spectrum” control from a device or set of devices.

The message may further request a list of devices that have some spectrum control in place.

The message may include a time limit for the control.

The message may use FCC-Id or manufacturer or device product name or device serial number to identify the device or set of devices.

The message may include a geographical area within which the control applies to a device of set of devices.

FIG. 2 illustrates the operation of an AFC system 102, the AFC service provider 104, the AFC service provider database 106, and the authorized entity 108 in accordance with one example embodiment of the present disclosure. As illustrated, an AFC service provider 104 (or AFC operator) sends, to the AFC service provider database 106, a request to add, modify, delete, or view a data record(s) related to the AFC service provider 104 and/or the AFC system 102 of the AFC service provider 104 (step 200). In the illustrated example, this request is sent via an exposed Application Programming Interface (API) of the AFC service provider database 106. Preferably, the request is sent over a secure, authenticated connection. For example, an new AFC service provider 104 (or new AFC operator) may add a new record which includes contact details (e.g., IP address(es), URL(s), etc.) and optionally the geographic location or geographic region where the AFC service provider 104 is providing service (i.e., via the associated AFC system 102) and/or frequency range(s) for which the AFC service provider 104 is providing service (i.e., via the associated AFC system 102), and/or the FCC-IDs of devices for which the AFC service provider 104 is providing service (i.e., via the associated AFC system 102). As another example, an existing AFC service provider 104 may modify, delete, or view an existing record in the AFC service provider database 106.

Responsive to receiving the request, the AFC service provider database 106 performs the requested action (step 202). More specifically, the AFC service provider database 106 adds provided information related to the AFC service provider 104 and/or the associated AFC system 102 to the AFC service provider database 106, modifies an existing database record(s) related to the AFC service provider 104 and/or the associated AFC system 102 based on information provided in the request, deletes a record(s) related to the AFC service provider 104 and/or the associated AFC system 102 from the AFC service provider database 106, or returns a requested database record(s) related to the AFC service provider 104 and/or the associated AFC system 102 to the AFC service provider 104, as requested. Note that steps 200 and 202 may be M2M procedures and are performed by each AFC service provider 104. Further, the AFC service provider 104 may send multiple requests to perform multiple operations.

The AFC service provider database 106 may also be utilized by the authorized entity 108. In the illustrated example, the authorized entity 108 sends a query for AFC service providers to the AFC service provider database 106 (step 204). The query may include one or more criteria such as, e.g., a geographic location or geographic region (e.g., city, state, or the like), a time range, a frequency(s) or frequency range(s) of interest, FCC-ID(s), or the like. In response to the query, the AFC service provider database 106 searches its records for AFC service providers that satisfy the query (e.g., that satisfy the one or more criteria in the query) and returns resulting list of AFC service providers to the authorized entity 108 (step 206). In one embodiment, the list includes the IP address(es) or URL(s) for the AFC service provider(s) 104 and/or the associated AFC system(s) 102. In one embodiment, the query and response are via a secure, authenticated connection. The list of AFC service providers may include information (e.g., a URL) for the AFC systems 102 associated to the AFC service providers 104 in the list.

In this example, the authorized entity 108 sends an inquiry request to the AFC system 102 (e.g., the AFC system 102 associated to one of the AFC service providers 104 included in the list of step 206), e.g., using the contact information (e.g., IP address or URL) included in the list of step 206 (step 208). The inquiry request may include one or more criteria such as, for example, a list of devices to which the inquiry request relates, a geographic location or region to which the inquiry request relates, a time range, a frequency or frequency range of interest to which the inquiry request relates, an FCC-ID(s) to which the inquiry request relates, or the like). The AFC system 102 searches its records (or an associated AFC database) for devices that satisfy the criteria specified in the inquiry request and sends a corresponding response to the authorized entity 108 (step 210). This response may include, e.g., a list of devices (e.g., base stations or access points) that satisfy the inquiry request and, optionally, contact information for the respective devices or associated network contacts (e.g., IP addresses of the respective devices or contact info for the respective network administrators). In one embodiment, the inquiry request is a request to deny spectrum to one or more devices. This denial may be a complete denial or a denial to parts of the spectrum. Note that there may also be a message to remove denial.

FIG. 3 illustrates the operation of an AFC system 102, the AFC service provider database 106, an incumbent operator 114, and an incumbent system 112 of the incumbent operator 114 in accordance with one example embodiment of the present disclosure. As illustrated, the incumbent operator 114 may interact with the AFC service provider database 106 to be added as an authorized user of the AFC service provider database 106 (step 300). This procedure may be the same as or similar to the existing ULS database updates by an incumbent operator. The AFC system 102 (e.g., a log management function of the AFC system 102) queries the AFC service provider database 106 for a list of authorized users (i.e., an authorized user access list) (step 302). The AFC service provider database 106 returns the authorized user access list to the AFC system 102 (step 304). The authorized user access list may be a list of users (e.g., incumbent system operator(s) 114, authorized entity(s) 108, etc.) that are authorized to access the AFC service provider database 106 and/or the AFC system 102.

In the course of operation, the incumbent operator 114 performs performance measurements and/or monitoring of the associated incumbent system 112 and suspects some form of external interference (e.g., ruled out internal, microwave system causes possibly using regular procedures, e.g., site visits, etc.) (step 306). The incumbent operator 114 sends a query (e.g., via a secure, authenticated communication) for AFC service providers (e.g., that satisfy one or more criteria such as, e.g., a geographic criterion such as, e.g., being at the geographic location or region at which the associated incumbent system 112 is located) (step 308). The AFC service provider database 106 returns a list of AFC service providers 104 that satisfy the query (step 310). The incumbent operator 114 sends an inquiry request to the AFC system 102 of one of the AFC service providers 104 listed in the query response (step 310). The inquiry request may include one or more criterion such as, e.g., a geographic location or region, a time range, a frequency or frequency range, or the like (step 312). The geographic location or region may be that at/in which the incumbent system 112 is located. The time range may be, for example, a time range during which the incumbent system 112 is experiencing interference. The frequency or frequency range may be the frequency or frequency range at/in which the incumbent system 112 is operating. The AFC system 102 returns an inquiry response that includes a list of devices that satisfy the inquiry request and, in this example, contact information for the associated contact person/entity (step 314). The inquiry request/response may be via, e.g., HTTPS secure interface to the AFC system 102. Further, the inquiry request/response may be repeated for multiple AFC systems (e.g., multiple AFC systems associated to the AFC service providers included in the list contained in the query response of step 310. The incumbent operator 114 may then contact the network entity 110 (e.g., network operator) of the device(s) indicated in the inquiry response to initiate an investigation (step 316). The contacted entity may, for example, provide system and spectrum information to the incumbent operator 114 and/or may assist in joint investigation of the potential interference issue (step 318).

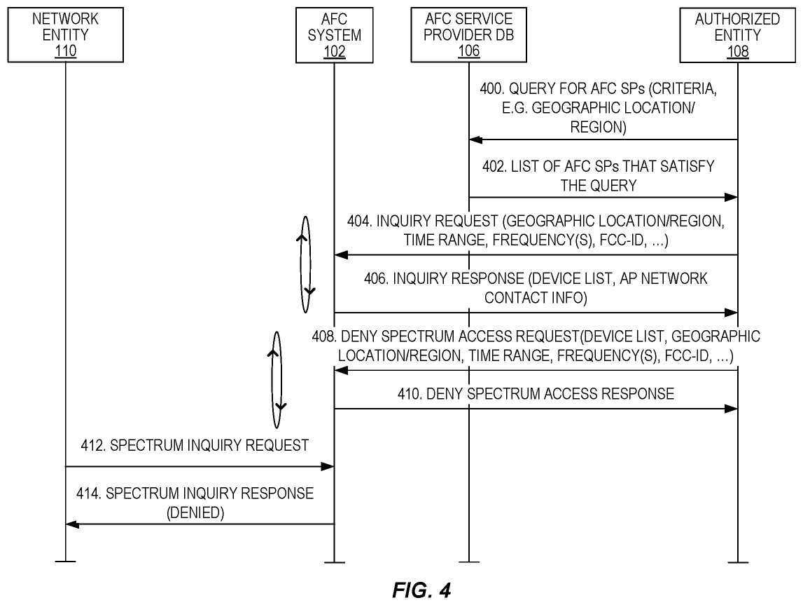

FIG. 4 illustrates the operation of an AFC system 102, the AFC service provider database 106, the authorized entity 108, in accordance with one example embodiment of the present disclosure. As illustrated, the authorized entity 108 sends a query to the AFC service provider database 106 for AFC service providers, e.g., that satisfy one or more criteria specified in the query (500). The one or more criteria may include, for example, a geographic location or region, a time range, a frequency or frequency range, or the like. In response, the AFC service provider database 106 returns a list of AFC service providers 104 that satisfy the query (step 402). The authorized entity 108 may then query one or more AFC systems 102 of one or more AFC service providers 104 indicated in the list for a list of devices that satisfy one or more criteria (e.g., a geographic location or region, a time range, a frequency or frequency range, or the like). For each such AFC system 102, the authorized entity 108 sends an inquiry request to the AFC system 102 (e.g., to a management function of the AFC system 102), where the inquiry request includes the one or more criteria (step 404). The one or more criteria may include, e.g., a geographic location(s) or region(s), a time range(s), a frequency(s) or frequency range(s), or the like. In response, the AFC system 102 returns an inquiry response that includes a list of devices (that have registered with the AFC system 102) that satisfy the one or more criteria specified in the inquiry request (step 406). Steps 404 and 406 are repeated for each AFC system 102 to be queried by the authorized entity 108.

The authorized entity 108 may then send a spectrum access control request to one or more of the queried AFC systems 102 (step 408). The request may be a request to apply control (e.g., deny access or partial denial of access), view control, or remove control of spectrum access. For example, the spectrum access control request may include:
Action Parameter: A parameter that specifies whether the requested action is to apply control, view control, or remove control.
Control Parameter (Optional): If the action parameter indicates that the requested action is to apply control or remove control, the spectrum access control request may further include a control parameter that indicates that the requested control to be added or removed is to deny access to a frequency range(s) or to allow access to a frequency range(s).
Device List Parameter (Optional): This parameter may include a list of devices (e.g., a list of device IDs) to which the requested action/control is to be applied.
Geographic Location/Region Parameter (Optional): This parameter indicates a geographic location(s) or region(s) in which requested action is to be applied.
Frequency Range(s) Parameter (Optional): This parameter indicates the frequency(s) or frequency range(s) for which the requested action/control (e.g., denial of access or permission to access) is to be applied.
FCC-ID(s) Parameter (Optional): This parameter indicates one or more FCC-IDs for which the requested action/control is to be applied.

For example, no Device List or FCC-ID or geography parameters may be included in the request, and the request may apply for all devices matching the Frequency Range(s) parameter. As another example, to deny use of the frequency range 6100 MHz-6300 MHz for all devices, the Spectrum Access Control Request may be: Action=ApplyControl, Control=DenyFrequencyRange, Frequency Range list=6100 MHz-6300 MHz. The AFC system 102 may return a spectrum access control response indicating, e.g., an acknowledgement of the request to deny spectrum access (step 410). In one embodiment, the contents of the spectrum access control response depends on the parameters used in the spectrum access control request. In one embodiment, the spectrum access control response includes a “Return Code” that indicates the success or failure of processing the spectrum access control request. For example, if the spectrum access control request contained “Action”=ViewControl and a Device List, the spectrum access control response may contain the AFC control status of the devices in the Device List, e.g.:
Device01, AFC Control status=No Restrictions;
Device02, AFC Control status=Restricted frequency range 6270 MHz-6570 MHz, Restriction: max EIRP=10 dBm;
Device03, AFC Control status=Restricted frequency range 6270 MHz-6570 MHz, Restriction: Not for use.

As another example, if the spectrum access control request contained “Action”=ApplyControl where control=Deny and a FrequencyRange=6200 MHz-6400 MHz and the AFC system 102 successfully applied the Action, then the spectrum access control response may contain a return code=Success.

A base station, access point, fixed client, or network manager may send a spectrum inquiry request to the AFC 102 and, in response, receive a spectrum inquiry response that indicates, e.g., that access to the requested spectrum is denied (steps 412 and 414). For example, if the spectrum inquiry request is made for a device for which spectrum access was denied in step 410, the spectrum inquiry response would indicate that spectrum access is denied or partially denied (e.g., access is denied for only a portion of the spectrum for which the inquiry was made, access is denied only during specific time ranges, access is denied only for a portion of a geographic region for which the inquiry was made, or the like).

Note that FIGS. 2, 3, and 4 illustrate multiple aspects of the present disclosure. It is to be appreciated that while some of these aspects are shown together in a single figure, these aspects may be used separately in one or more embodiments.

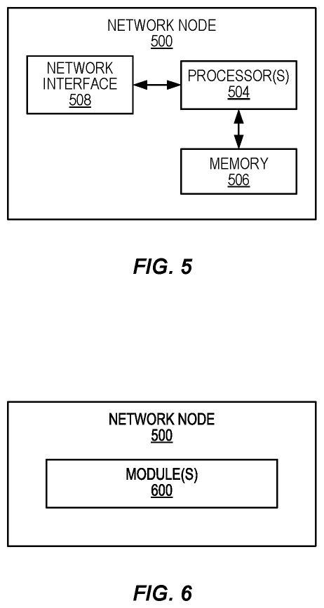

FIG. 5 is a schematic block diagram of a network node 500 according to some embodiments of the present disclosure. Optional features are represented by dashed boxes. The network node 500 may be, for example, a network node 500 that implements an AFC system 102, a network node used by an AFC service provider 104 to access the system 100, a network node that implements the AFC service provider database 106, a network node used by the authorized entity 108 to access the system 100, a network node corresponding to the network entity 110, a network node corresponding to the incumbent system 112, or a network node used by the incumbent operator 114 to access the system. As illustrated, the network node 500 includes one or more processors 504 (e.g., Central Processing Units (CPUs), Application Specific Integrated Circuits (ASICs), Field Programmable Gate Arrays (FPGAs), and/or the like), memory 506, and a network interface 508. While not illustrated, the network node 500 may, in some cases, include additional component that are not illustrated in FIG. 5 (e.g., one or more displays, one or more user input devices (e.g., touchscreen, keypad, mouse, etc.), a power supply, or the like). The one or more processors 504 are also referred to herein as processing circuitry. The one or more processors 504 operate to provide one or more functions of the network node 500 as described herein (e.g., one or more functions of the AFC system 102, one or more functions associated to the AFC service provider 104, one or more functions of the AFC service provider database 106, one or more functions associated to the authorized entity 108, one or more functions of the network entity 110, one or more functions of the incumbent system 112, or one or more functions associated to the incumbent operator 114, as described herein). In some embodiments, the function(s) are implemented in software that is stored, e.g., in the memory 506 and executed by the one or more processors 504.

In some embodiments, a computer program including instructions which, when executed by at least one processor, causes the at least one processor to carry out the functionality of the network node 500 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 6 is a schematic block diagram of the network node 500 according to some other embodiments of the present disclosure. The network node 500 includes one or more modules 600, each of which is implemented in software. The module(s) 600 provide the functionality of the network node 500 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

Embodiment 1: A method performed by an Automatic Frequency Coordination, AFC, service provider database that maintains records of AFC service providers and/or AFC systems, the method comprising: receiving, from a network node associated with an AFC service provider or AFC operator, a request to add, modify, delete, or view information about the AFC service provider and/or an AFC system of the AFC service provider; and performing one or more actions responsive to the request.

Embodiment 2: The method of embodiment 1 further comprising: receiving, from an authorized entity, a query for AFC service providers; and responsive to receiving the query, sending, to the authorized entity, a query response that comprises a list of AFC service providers that satisfy the query.

Embodiment 3: The method of embodiment 2 wherein the query comprises one or more criteria, and the list of AFC service providers comprises one or more AFC service providers that satisfy the one or more criteria comprised in the query.

Embodiment 4: The method of embodiment 3 wherein the one or more criteria comprised in the query comprise a geographic location, a geographic region, a time range, a frequency, a frequency range, and/or an FCC-ID.

Embodiment 5: The method of any of embodiments 1 to 4 further comprising communicating with one or more incumbent operators to update an authorized user access list for the AFC service provider database.

Embodiment 6: The method of embodiment 1 further comprising:
receiving, from an incumbent operator, a query for AFC service providers; and responsive to receiving the query, sending, to the incumbent operator, a query response that comprises a list of AFC service providers that satisfy the query.

Embodiment 7: The method of embodiment 6 wherein the query comprises one or more criteria, and the list of AFC service providers comprises one or more AFC service providers that satisfy the one or more criteria comprised in the query.

Embodiment 8: The method of embodiment 7 wherein the one or more criteria comprised in the query comprise a geographic location, a geographic region, a time range, a frequency, a frequency range, and/or an FCC-ID.

Embodiment 9: The method of any of embodiments 1 to 8 further comprising: receiving, from an AFC system, a query for an authorized user access list; and sending the authorized user access list to the AFC system responsive to receiving the query for the authorized user access list.

Embodiment 10: A method performed by an Automatic Frequency Coordination, AFC, service provider database that maintains records of AFC service providers and/or AFC systems, the method comprising: receiving, from another entity, a query for AFC service providers; and responsive to receiving the query, sending, to the other entity, a query response that comprises a list of AFC service providers that satisfy the query.

Embodiment 11: The method of embodiment 10 wherein the query comprises one or more criteria, and the list of AFC service providers comprises one or more AFC service providers that satisfy the one or more criteria comprised in the query.

Embodiment 12: The method of embodiment 11 wherein the one or more criteria comprised in the query comprise a geographic location, a geographic region, a time range, a frequency, a frequency range, and/or an FCC-ID.

Embodiment 13: A network node adapted to perform the method of any of embodiments 1 to 12.

Those skilled in the art will recognize improvements and modification to the embodiments of the present disclosure. All such improvements and modifications are considered within the scope of the concepts disclosed herein.

1. A method performed by an Automatic Frequency Coordination, AFC, service provider database that maintains records of AFC service providers and/or AFC systems, the method comprising:
receiving, from a network node associated with at least one of an AFC service provider or an AFC operator, a request to add, modify, delete, or view information about the AFC service provider and/or an AFC system of the AFC service provider; and
performing an action responsive to the request.

2. The method of claim 1 further comprising:
receiving, from an authorized entity, a query for AFC service providers; and
responsive to receiving the query, sending, to the authorized entity, a query response that comprises a list of AFC service providers that satisfy the query.

3. The method of claim 2 wherein the query comprises criteria, and the list of AFC service providers comprises one or more AFC service providers that satisfy the criteria comprised in the query.

4. The method of claim 3 wherein the criteria comprised in the query comprises at least one of a geographic location, a geographic region, a time range, a frequency, a frequency range, and/or a Federal Communication Commission Identifier, FCC-ID.

5. The method of claim 1 further comprising:
communicating with an incumbent operator to update an authorized user access list for the AFC service provider database.

6. The method of claim 1 further comprising:
receiving, from an incumbent operator, a query for the AFC service providers; and
responsive to receiving the query, sending, to the incumbent operator, a query response that comprises a list of AFC service providers that satisfy the query.

7. The method of claim 6 wherein the query comprises criteria, and the list of AFC service providers comprises one or more AFC service providers that satisfy the criteria comprised in the query.

8. The method of claim 7 wherein the criteria comprised in the query comprises at least one of a geographic location, a geographic region, a time range, a frequency, a frequency range, and/or a Federal Communication Commission Identifier, FCC-ID.

9. The method of claim 1 further comprising:
receiving, from an AFC system, a query for an authorized user access list; and
sending the authorized user access list to the AFC system responsive to receiving the query for the authorized user access list.

10. A method performed by an Automatic Frequency Coordination, AFC, service provider database that maintains records of AFC service providers and/or AFC systems, the method comprising:
receiving, from another entity, a query for AFC service providers; and
responsive to receiving the query, sending, to the other entity, a query response that comprises a list of AFC service providers that satisfy the query.

11. The method of claim 10 wherein the query comprises criteria, and the list of AFC service providers comprises one or more AFC service providers that satisfy the criteria comprised in the query.

12. The method of claim 11 wherein the criteria comprised in the query comprises at least one of a geographic location, a geographic region, a time range, a frequency, a frequency range, and/or a Federal Communication Commission Identifier, FCC-ID.

13. The method of claim 10, wherein the other entity is at least one of an authorized entity or an incumbent system operated by an incumbent operator.

14. A network node, comprising processing circuitry configured to cause the network node to:
receive, from another network node associated with at least one of an AFC service provider or an AFC operator, a request to add, modify, delete, or view information about the AFC service provider and/or an AFC system of the AFC service provider; and
perform an action responsive to the request.

15. The network node of claim 14, wherein the processing circuitry is further configured to cause the network node to:
receive, from an authorized entity, a query for AFC service providers; and
responsive to receiving the query, send, to the authorized entity, a query response that comprises a list of AFC service providers that satisfy the query.

16. The network node of claim 15, wherein the query comprises criteria, and the list of AFC service providers comprises one or more AFC service providers that satisfy the criteria comprised in the query.

17. The network node of claim 16, wherein the criteria comprised in the query comprises at least one of a geographic location, a geographic region, a time range, a frequency, a frequency range, and/or a Federal Communication Commission Identifier, FCC-ID.

18. The network node of claim 14, wherein the processing circuitry is further configured to cause the network node to:
communicate with an incumbent operator to update an authorized user access list for the AFC service provider database.

19. The network node of claim 14, wherein the processing circuitry is further configured to cause the network node to:
receive, from an incumbent operator, a query for the AFC service providers; and
responsive to receiving the query, sending, to the incumbent operator, a query response that comprises a list of AFC service providers that satisfy the query.

20. The network node of claim 19, wherein the query comprises criteria, and the list of AFC service providers comprises one or more AFC service providers that satisfy the criteria comprised in the query.
